(19) United States
(12) Patent Application Publication
(10) Pub. No.: US 2023/0370939 A1
(43) Pub. Date: Nov. 16, 2023

(54) METHOD FOR CONFIGURING UAV NETWORK BY UTILIZING MULTIMODAL SENSOR INFORMATION

(71) Applicant: AJOU UNIVERSITY INDUSTRY-ACADEMIC COOPERATION FOUNDATION, SUWON-SI, GYEONGGI-DO (KR)

(72) Inventors: Young Bae KO, Suwon-si (KR); Doo Ho KEUM, Seocho-gu (KR)

(21) Appl. No.: 18/266,581

(22) PCT Filed: Dec. 9, 2021
(86) PCT No.: PCT/KR2021/018632

§ 371 Date: Aug. 3, 2023

(30) Foreign Application Priority Data
Dec. 10, 2020 (KR) 10-2020-0172731

(51) Int. Cl. H04W 40/02; H04W 28/02; H04W 40/20; H04W 40/12

(52) U.S. Cl. CPC H04W 40/026; H04W 28/0226; H04W 40/20; H04W 28/021; H04W 40/12

(57) ABSTRACT

The present invention relates to a device and a method for configuring the topology of a UAV network having a plurality of unmanned air vehicles, the device and the method using the current location, moving speed, and movement direction of respective unmanned air vehicles to predict the locations of the unmanned air vehicles, and predicting a topology enabling an optimum network to be configured in consideration of meteorological influence and link quality, and thus a more stable UAV network can be configured.

### TECHNICAL FIELD

The present invention relates to a network configuration using unmanned aerial vehicles (UAV).

### BACKGROUND ART

Recently, as the FANET (Flying Ad Hoc Network) communication technology utilizing unmanned aerial vehicles (UAV) has been developed, it has been utilized in various services such as delivery service and traffic volume monitoring. These services can provide safe and essential information only when the movement path and location information of the UAVs can be known in advance. However, in the FANET environment, the network performance may be reduced due to the rapid movement of UAVs and weather changes. Therefore, it is required to develop a data transmission technique including the topology configuration technology in order to ensure network performance in consideration of the location, mobility and weather change factors of the UAV.

In order to solve the problem of reducing the performance of such a network, a number of DTN (Delay Tolerant Network)-based routing protocols using the GPS information of UAVs have been proposed. However, the method of using the current location information for path selection has difficulties in reflecting information on how the topology will change in the future in a finely moving UAV network. In addition, UAVs in the FANET environment are greatly affected by meteorological conditions, and research on technology for data transmission in consideration of weather information is insufficient.

The inventors of the present invention have studied to solve the problem of network performance reduction due to the movement of UAVs in the FANET environment of the related art. After much effort, the present invention was completed in order to complete a device and method for configuring the topology of a network that can transmit data safely and quickly in consideration of UAV mobility and weather change factors.

### DISCLOSURE

### Technical Problem

An object of the present invention is to predict a more accurate network environment and configure a topology by using sensor information together with the movement information of UAVs in a FANET environment that is configured by a plurality of UAVs.

Meanwhile, other objects that are not specified in the present invention will be additionally considered within the range that can be easily inferred from the following detailed description and effects thereof.

### Technical Solution

The method for configuring the topology of a network configured by a plurality of unmanned aerial vehicles according to the present invention may include the steps of (a) receiving current location, movement direction, speed and sensor information of each unmanned aerial vehicle; (b) calculating location and link quality of each unmanned aerial vehicle after a predetermined time by using the current location, the movement direction, the speed and the sensor information; and (c) configuring a network topology that is capable of communication in the shortest time or with the highest quality according to the calculated location and the link quality.

Step (b) may correct the location of each unmanned aerial vehicle after the predetermined time according to wind direction and wind velocity information among the sensor information.

Step (b) may receive the sensor information from the plurality of unmanned aerial vehicles configuring the network.

In step (c), the period of receiving the sensor information may be adjusted by using the wind velocity information among the sensor information.

Step (c) may determine network quality by using the sensor information.

Step (c) may determine the network speed or network quality by using the movement direction of each unmanned aerial vehicle, angle between neighboring nodes and the link quality at the calculated location.

The device for configuring the topology of a UAV network according to an exemplary embodiment of the present invention may include a communicator for receiving current location, movement direction, speed and sensor information of each unmanned aerial vehicle from a plurality of unmanned aerial vehicles; and a controller for calculating location of each unmanned aerial vehicle after a predetermined time in consideration of weather information by using the current location, the movement direction, the speed and the sensor information, and configuring a network topology that is capable of communication in the shortest time or with the highest quality according to the calculated location.

The controller may correct the location of each unmanned aerial vehicle after a predetermined time according to wind direction and wind velocity information among the sensor information.

The controller may receive the sensor information from a plurality of unmanned aerial vehicles configuring the network.

In the controller, the period of receiving the sensor information may be adjusted by using wind velocity information among the sensor information.

The controller may determine network quality by using the sensor information.

The controller may determine the network speed or network quality by using the movement direction of each unmanned aerial vehicle, the angle between neighboring nodes and the link quality at the calculated location.

### Advantageous Effects

According to the present invention, by using the sensor information and the movement information of the UAV together, it is possible to more accurately grasp a network topology that changes from moment to moment.

In addition, it has the advantage of configuring a safe and fast network by more accurately predicting the location of the UAV.

Meanwhile, even if it is an effect that is not explicitly mentioned herein, it is added that the effects described in the following specification that are expected by the technical features of the present invention and their potential effects are treated as described in the specification of the present invention.

### DESCRIPTION OF DRAWINGS

FIG. 1 is a flowchart of the method for configuring the topology of a UAV network according to a preferred exemplary embodiment of the present invention.

FIGS. 2 and 3 show configuration examples of UAVs for configuring the topology of a UAV network according to a preferred exemplary embodiment of the present invention.

FIG. 4 is a structural diagram of the device for configuring the topology of a UAV network according to a preferred exemplary embodiment of the present invention.

※ It is noted that the accompanying drawings are exemplified as references for understanding the technical idea of the present invention, and the scope of the present invention is not limited thereby.

### Modes of the Invention

Hereinafter, the configuration of the present invention guided by various exemplary embodiments of the present invention and the effects resulting from the configuration will be described with reference to the drawings. In the description of the present invention, if it is determined that related known functions are obvious matters to those skilled in the art and may unnecessarily obscure the gist of the present invention, the detailed description thereof will be omitted.

Terms such as ‘first’ and ‘second’ may be used to describe various components, but the components should not be limited by the above terms. The above terms may be used only for the purpose of distinguishing one component from another. For example, without departing from the scope of the present invention, a ‘first component’ may be termed a ‘second component’, and similarly, a ‘second component’ may also be termed a ‘first component’. In addition, the singular expression includes the plural expression unless the context clearly dictates otherwise. Unless otherwise defined, terms used in the exemplary embodiments of the present invention may be interpreted as meanings commonly known to those of ordinary skill in the art.

Hereinafter, the configuration of the present invention guided by various exemplary embodiments of the present invention and the effects resulting from the configuration will be described with reference to the drawings.

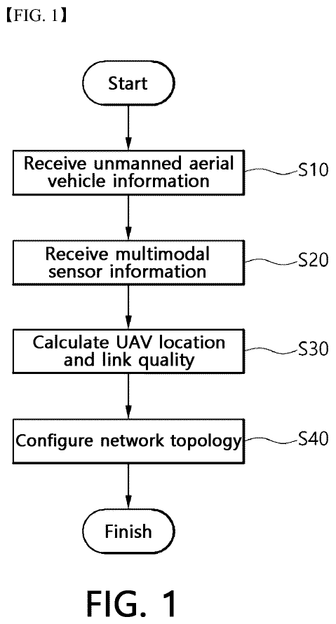

FIG. 1 is a flowchart of the method for configuring the topology of a UAV network according to a preferred exemplary embodiment of the present invention.

The method for configuring the topology of a UAV network may be performed by each UAV constituting the UAV network or a server of a base station (BS) for communication.

In a network (FANET) configured by a plurality of unmanned aerial vehicles (UAVs), in order to configure a network with unmanned aerial vehicles, the location of the unmanned aerial vehicle must be identified. Therefore, information about the unmanned aerial vehicle is received first (S10).

It will also be possible to receive information about unmanned aerial vehicles from each neighboring unmanned aerial vehicle or collectively from a base station that integrates and manages information about unmanned aerial vehicles.

The information about the unmanned aerial vehicle may include the current location, movement direction, speed, acceleration and the like of the unmanned aerial vehicle.

Sensor information is also received along with information about the unmanned aerial vehicle (S20). The sensor information is used to correct the location of the unmanned aerial vehicle or to understand the network situation.

The sensor information according to an exemplary embodiment of the present invention may be obtained from a multimodal sensor. A multimodal sensor refers to a sensor to which the modality technology is applied, which is an environment for interactive communication between a user and an electronic device by the fusion of various input methods such as voice, gesture and bio-signals, in addition to text.

The information about unmanned aerial vehicles and sensor information may use a Hello Packet. The Hello Packet is a message which is exchanged to prevent collision between unmanned aerial vehicles and is used in the present invention to exchange location information and sensor information for unmanned aerial vehicles. The hello packet may be received by a neighboring unmanned aerial vehicle or may be received by a base station.

Table 1 below shows an example of a Hello Packet.

TABLE 1

| | | | | | | | | | | | |
|---|---|---|---|---|---|---|---|---|---|---|---|
| Msg ID | Node ID | IP | Position | Velocity | Angle | Acceleration | Wind | Wind | Temperature | RSSI | Neighbor |
| | | Address | | | | | Velocity | Direction | | PER | node list |

The Hello Packet may include message ID (Msg ID), node ID, IP address, position, velocity, movement direction (Angle), acceleration, wind velocity, wind direction, temperature, received signal strength indication, packet error rate (PER), a neighbor node list and the like.

Such sensor information may be received with a different cycle depending on weather conditions. Accuracy may be improved if more weather information is collected by making the cycle faster, but it is necessary to consider the same at an appropriate level because it can be a burden on the network by transmitting and receiving a lot of data. Therefore, in the present invention, the reception period of the hello packet may be adjusted as shown in Table 2 below according to the wind velocity, the unmanned aerial vehicle and the like.

TABLE 2

| Wind velocity | 0~10 m/s | 10~20 m/s | 20~30 m/s | 30~40 m/s | 40 m/s~ |
|---|---|---|---|---|---|
| Hello packet | 2 s | 1 s | 0.8 s | 0.5 s | 0.1 s |
| interval | | | | | |

Assuming that the maximum communication range per hop is 3 km, the time for maintaining the UAV location at 10 to 20 m per second may be set as a stable Hello Packet reception period. In this case, generally, wind at 25 m/s or more is assumed as a typhoon.

According to an exemplary embodiment of the present invention, network overhead may be reduced by adaptively adjusting the reception period of the shared Hello Packet according to multimodal sensor information for optimal routing metric calculation.

After receiving the information in this way, the next location and link quality of the nodes constituting the UAV network, that is, the unmanned aerial vehicles, are calculated by using the information (S30).

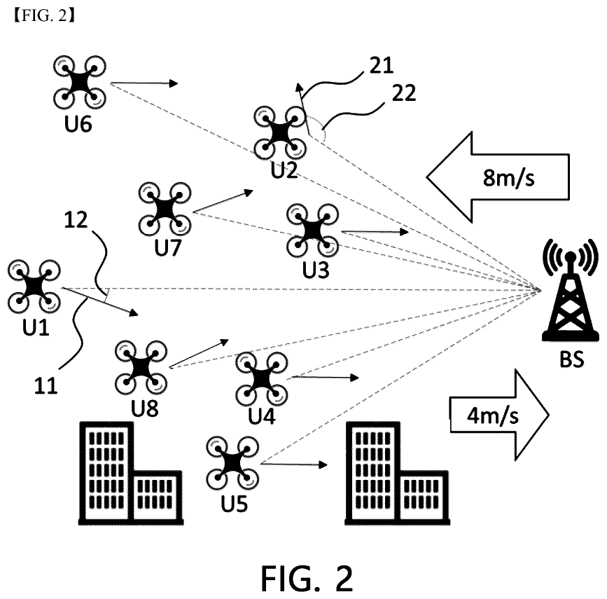

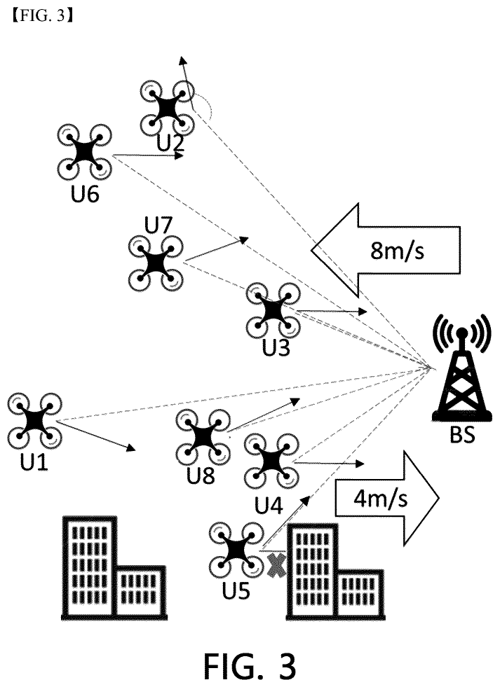

FIGS. 2 and 3 show configuration examples of UAVs for configuring the topology of a UAV network according to a preferred exemplary embodiment of the present invention.

In FIG. 2, each of the unmanned aerial vehicles U1 to U8 has a different current location and a different movement direction.

FIG. 3 shows the locations of each unmanned aerial vehicle after a predetermined time has elapsed.

In order to predict the next locations of unmanned aerial vehicles, it is necessary to consider not only the movement direction and speed of the unmanned aerial vehicle and the altitude measurement using the barometric pressure sensor, but also the weather conditions. For example, if the wind blows in the same direction as the movement direction, the moving speed will be faster, and if the reverse wind blows, the moving speed will be slower, and thus, this must be reflected in the location prediction. Alternatively, when the humidity is high or it is raining, it must be considered that the movement speed may be slower than on a sunny day.

In the unmanned aerial vehicles U2, U3, U6, U7 that are located on the upper side in FIG. 2, the direction of the wind is opposite to the movement direction, whereas in the unmanned aerial vehicles U4, U5, U8 that are located on the lower side, the direction of the wind and the movement direction are the same, and thus, it is possible to predict that the unmanned aerial vehicles on the upper side will be slower, and the unmanned aerial vehicles on the lower side will be faster. The degree of slowing down or speeding up may take into account both of wind velocity and wind direction.

Therefore, the next location of unmanned aerial vehicles is calculated by considering these situations comprehensively.

At the current location of FIG. 2, it is possible to configure a topology in which the unmanned aerial vehicle U1 passes through U7 and U3 or passes through U8 and U4 to communicate with the base station.

However, after a predetermined time has elapsed, when the situation of FIG. 3 occurs, the unmanned aerial vehicle U7 moves away from U1, and it becomes inefficient to configure the topology by using U7. Accordingly, in FIG. 3, it may be possible to configure a topology in which U1 is connected to a base station via U8 and U3 or to a base station via only U4. In the case of U5, if an uncertain situation is encountered (obstacles, etc.) through link quality calculation such as received signal strength indication (RSSI) and packet error rate (PER), the movement path may be changed to avoid the same, and thus, it may arrive late to the BS. Each node compares its own value with that of a neighboring node's routing metric, and if its own value is high, it may be transmitted directly to the base station, and the routing metric may calculate an optimal value by including information up to the destination received by the neighbors.

More specifically, the optimal routing metric (ORM) may be calculated by using Mathematical Formula 1 as follows.

$$O R M = ( {W}_{1} \times HLQM ) + ( {W}_{2} \times δ ) + \frac{MAX}{θ} \qquad [ Mathematical Formula 1 ]$$

(ORM: optimal routing metric, HLQM: link quality value, δ: location prediction value, angle between the movement direction of the UAV and the base station (0<θ<MAX), W: weight)

In this case, it is assumed that the location prediction value δ (0 to 100) increases as it is closer to the base station, and the HLQM (0 to 100) value increases as the quality increases through a transformation function.

The weight W is adaptively adjusted according to multimodal sensor information. For example, the sum of the weights W1, W2 may be set to 1, and the higher the wind velocity, the more weight may be added to the location prediction value δ. That is, the value of W2 may be set to be larger than that of W1. Conversely, the slower the wind velocity, the more weight may be placed on the link quality value (HLQM). That is, the value of W1 may be set to be larger than that of W2.

When estimating the location in this way, along with weather information, the direction of movement of the unmanned aerial vehicle and the direction with the base station must be considered.

According to an exemplary embodiment of the present invention, it is assumed that the range of the angle θ between the movement direction of the unmanned aerial vehicle and the base station ranges from 0 degrees to 180 degrees, and MAX is 180 degrees.

In FIG. 2, in the case of the unmanned aerial vehicle U1, it can be confirmed that the angle 12 between the movement direction 11 and the base station is small. On the other hand, the unmanned aerial vehicle U2 has a large angle 22 between the movement direction 21 and the base station. Therefore, it may be determined that U1 is directed toward the base station, and U2 does not face the base station.

Therefore, even if the unmanned aerial vehicles are at similar distances, the unmanned aerial vehicle directed toward the base station may be more advantageous in terms of signal quality in configuring the network topology.

Table 3 below calculates the locations of each unmanned aerial vehicle by using sensor information, and shows the predicted connectivity information of nodes (unmanned aerial vehicles) for each time as an example.

TABLE 3

| Time Node | t | t + 1 | t + 2 | t + 3 | t + 4 | t + 5 | t + 6 |
|---|---|---|---|---|---|---|---|
| U1 | U7, U8 | U8 | — | — | — | — | — |
| | (Select the next | | | | | | |
| | hop after | | | | | | |
| | comparing the | | | | | | |
| | optimal routing | | | | | | |
| | metric value of | | | | | | |
| | each node) | | | | | | |
| U2 | U3, U6, U7 | U6, U7 | — | — | — | — | — |
| U3 | U2, U7 | U7 | U7 | U7 | BS | BS | — |
| U4 | U5, U8 | U5, U8 | U5, BS | U5, BS | U5, BS | U5, BS | — |
| U5 | U4, U8 | U4, U8 | U4 | U4 | U4 | U4, BS | — |
| U6 | U2, U7 | U2, U7 | — | — | — | — | BS |
| U7 | U1, U2, U3, U6 | U2, U3, U6 | — | — | — | — | — |
| U8 | U1, U4, U5 | U1, U4, U5 | — | — | — | — | — |
| | | (Select the next | | | | | |
| | | hop after | | | | | |
| | | comparing the | | | | | |
| | | optimal routing | | | | | |
| | | metric value of | | | | | |
| | | each node) | | | | | |

As shown in Table 3, it is possible to configure an optima network topology after the location prediction of the unmanned aerial vehicles and link quality calculation are completed (S40).

For example, U1 may transmit data by selecting U8, which has been calculated as an optimal routing metric by comparing routing metric values among neighboring nodes U7, U8, as a next hop. In addition, U8 may select U4, which has been calculated as an optimal routing metric among neighboring nodes U1, U4, U5, as a next hop, and transmits data or compares the same with itself to transmit directly to a base station. In this case, the optimal routing metric value may be calculated by including information up to the destination in the data packet.

When configuring the network topology, not only the distance from the neighboring node (unmanned aerial vehicle), but also the angle of the neighboring node, weather conditions such as temperature and humidity, and link quality may be considered.

Therefore, in order to configure the optimal network topology, it is possible to configure a topology in the shortest time or with the best quality by considering the movement speed, movement direction, altitude, angle with the base station, weather conditions and link quality of unmanned aerial vehicles.

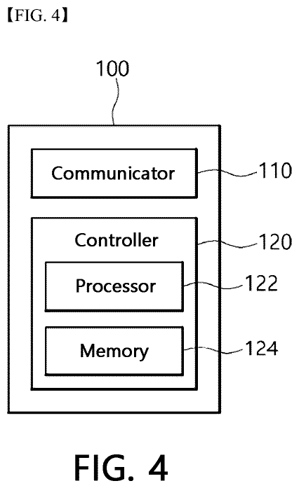

FIG. 4 is a structural diagram of the device for predicting the topology of a UAV network according to a preferred exemplary embodiment of the present invention.

The device 100 for predicting the topology of a UAV network according to the present invention includes a communicator 110 and a controller 120.

The device 100 for predicting the topology of a UAV network of the present invention may be an unmanned aerial vehicle or a server of a base station.

The communicator 110 is used for communication after receiving information from a base station or a neighboring unmanned aerial vehicle and also configuring a network.

Information received from a base station or a neighboring unmanned aerial vehicle may include information for determining the location of unmanned aerial vehicles and weather information.

In order to determine the location of an unmanned aerial vehicle, information such as the current location, movement direction, movement speed, acceleration and the like of the unmanned aerial vehicle is required.

In addition, the sensor information may include wind direction, wind velocity, temperature, humidity, rainfall/snowfall and the like.

The period of receiving such information may be adjusted according to the wind velocity. When the wind velocity is strong, the unmanned aerial vehicle is affected by the wind, and it is difficult to determine its location, and thus, it is necessary to receive sensor information frequently. However, when the wind velocity is weak, the flight of the unmanned aerial vehicle is stable, and thus, it is acceptable to lengthen the reception period.

The controller 120 predicts the next location of the unmanned aerial vehicles by using the received information and configures an optimal network topology. The optimal network topology means a topology configuration in which communication in the shortest time is possible or the network quality is the best.

To this end, the controller 120 may include one or more processors 122 and a memory 124. The processor 122 performs operations for predicting the locations of unmanned aerial vehicles or configuring a network topology, and the memory 124 may store program codes for driving the processor 122, data necessary for operations and the like.

The controller 120 calculates the locations of unmanned aerial vehicles after a predetermined time by using the current location, the movement direction and the moving speed of the unmanned aerial vehicles. In this case, the received weather information may be utilized. For example, if the wind velocity is above a certain level and the wind direction is headwind, the unmanned aerial vehicle may travel less than expected, and this must be taken into account.

After predicting the locations of the unmanned aerial vehicles after a predetermined time, the controller 120 may configure an optimal network topology in consideration of the node list, temperature, humidity, rainfall/snowfall and the like, in consideration of the locations of the unmanned aerial vehicles. When configuring the network topology, the network quality may be determined by using weather information such as temperature, humidity and rainfall/snowfall, and link quality in consideration of RSSI, PER and the like.

In addition, the controller 120 may determine the speed or quality of the network by using the angle between the movement direction of the unmanned aerial vehicle and the unmanned aerial vehicle or base station constituting the next hop.

According to the present invention as described above, rather than simply configuring a topology with nearby nodes (unmanned aerial vehicles), it has the effect of configuring a network topology that is capable of transmitting information in the shortest time or a network topology with the highest quality by using weather information that affects network conditions together.

The protection scope of the present invention is not limited to the description and expression of the exemplary embodiments explicitly described above. In addition, it is added once again that the protection scope of the present invention cannot be limited due to obvious changes or substitutions in the technical field to which the present invention pertains.

1. A method for configuring the topology of a network consisted by a plurality of unmanned aerial vehicles (UAV), the method comprising the steps of:
(a) receiving current location, movement direction, speed and sensor information of each unmanned aerial vehicle;
(b) calculating location and link quality of each unmanned aerial vehicle after a predetermined time by using the current location, the movement direction, the speed and the sensor information; and
(c) configuring a network topology that is capable of communication in the shortest time or with the highest quality according to the calculated location and the link quality.

2. The method of claim 1, wherein step (b) comprises correcting the location of each unmanned aerial vehicle after the predetermined time according to wind direction and wind velocity information among the sensor information.

3. The method of claim 1, wherein step (b) comprises receiving the sensor information from the plurality of unmanned aerial vehicles configuring the network.

4. The method of claim 3, wherein in step (c), the period of receiving the sensor information is adjusted by using the wind velocity information among the sensor information.

5. The method of claim 1, wherein step (c) comprises determining network quality by using the sensor information.

6. The method of claim 1, wherein step (c) comprises determining the network speed or network quality by using the movement direction of each unmanned aerial vehicle, angle between neighboring nodes and the link quality at the calculated location.

7. A device for configuring the topology of a UAV network, comprising:
a communicator for receiving current location, movement direction, speed and sensor information of each unmanned aerial vehicle from a plurality of unmanned aerial vehicles; and
a controller for calculating location of each unmanned aerial vehicle after a predetermined time in consideration of weather information by using the current location, the movement direction, the speed and the sensor information, and configuring a network topology that is capable of communication in the shortest time or with the highest quality according to the calculated location.

8. The device of claim 7, wherein the controller is configured to correct the location of each unmanned aerial vehicle after a predetermined time according to wind direction and wind velocity information among the sensor information.

9. The device of claim 7, wherein the controller receives the sensor information from a plurality of unmanned aerial vehicles configuring the network.

10. The device of claim 9, wherein in the controller, the period of receiving the sensor information is adjusted by using wind velocity information among the sensor information.

11. The device of claim 7, wherein the controller determines network quality by using the sensor information.

12. The device of claim 7, wherein the controller determines the network speed or network quality by using the movement direction of each unmanned aerial vehicle, the angle between neighboring nodes and the link quality at the calculated location.
